(19) United States
(12) Patent Application Publication
(10) Pub. No.: US 2017/0056292 A1
(43) Pub. Date: Mar. 2, 2017

(54) Temperature Sensing Syringe for Enteral Feeding Neonates

(71) Applicant: Covidien LP, Mansfield, MA (US)

(72) Inventors: Wayne Biermann, St. Charles, MO (US); Joel Wiesner, O'Fallon, MO (US); David Rork Swisher, St. Charles, MO (US); Michael Dorsey, Edwardsville, IL (US)

(21) Appl. No.: 15/242,645

(22) Filed: Aug. 22, 2016

Related U.S. Application Data
(60) Provisional application No. 62/210,779, filed on Aug. 27, 2015.

(51) Int. Cl. A61J 7/00

(52) U.S. Cl. CPC A61J 7/0053; A61J 2200/72; A61J 2205/20; A61J 2205/50

(57) ABSTRACT

A temperature-sensing syringe for enteral feeding of neonates includes a barrel for receiving enteral feeding liquid for a neonate, and a temperature-sensing component in thermal contact with the barrel. The temperature-sensing component detects the temperature of the enteral feeding liquid in the barrel of the syringe. The temperature sensing component provides an indication that the enteral feeding liquid is ready for feeding when the enteral feeding liquid is detected to be at about normal body temperature.

### CROSS-REFERENCE TO RELATED APPLICATION

The present application claims the benefit of, and priority to, U.S. Provisional Application Ser. No. 62/210,779, which was filed Aug. 27, 2015, which is incorporated herein by reference in its entirety for all purposes.

### FIELD

The present invention generally relates to a neonatal feeding syringe with temperature sensing or temperature indicating component or capability.

### BACKGROUND

In general, it has been found that warming enteral feeding liquid, e.g., breast milk, formula, water, or some combination, prior to administrating the liquid to a neonate is beneficial. In particular, warming the enteral feeding liquid to body temperature may promote greater feeding tolerance in neonates, particularly preterm infants. The enteral feeding liquid may be delivered using a syringe. Some clinicians or providers warm the enteral feeding liquid in the syringe using a warming bath or other methods. However, after warming the enteral feeding liquid in the syringe, the provider may not immediately feed the neonate. Instead, after warming, the syringe may be exposed to room temperature, and the temperature of the enteral feeding liquid begins to drop. After sitting at room temperature for some period of time, the provider no longer knows whether the temperature of the enteral feeding liquid in the syringe has dropped to sub-optimal or is not at the beneficial temperature for feeding.

### SUMMARY

In one aspect, a temperature sensing syringe for enteral feeding of neonates generally comprises a barrel for receiving enteral feeding liquid and a temperature sensing component in thermal contact with the barrel. The temperature sensing component is configured to detect the temperature of the enteral feeding liquid through the barrel of the syringe. The temperature sensing component provides an indication that the enteral feeding liquid is ready for feeding when the enteral feeding liquid is detected to be at about normal body temperature.

In another aspect, a method of facilitating delivery of a nutritional fluid to a neonate through a syringe generally comprises disposing a temperature-sensing component in thermal communication with a barrel of the syringe. The temperature-sensing component is configured to provide a visual indication of the temperature of the nutritional fluid to be contained in the barrel of the syringe. The temperature sensing component provides an indication that the nutritional liquid is ready for feeding when the nutritional liquid is detected to be at about normal body temperature.

In yet another aspect, a kit for facilitating delivery of a fluid to a neonate generally comprises a syringe having a barrel configured to contain the fluid to be delivered to the neonate and a means for providing a visual temperature indicator of the fluid to be contained in the barrel and an indication that the fluid is ready to be delivered to the neonate when the fluid is detected to be at about normal body temperature.

Other features will be in part apparent and in part pointed out hereinafter.

### BRIEF DESCRIPTION OF THE DRAWINGS

FIG. 1 is a side elevation of an embodiment of a temperature sensing syringe for enteral feeding of neonates;

FIG. 2 is a cross section of the temperature sensing syringe taken through the plane defined by the line 2-2 in FIG. 1;

FIG. 3 is a side elevation of another embodiment of a temperature sensing syringe for enteral feeding of neonates;

FIG. 4 is a cross section of the temperature sensing syringe taken through the plane defined by the line 4-4 in FIG. 3;

FIG. 5 is a side elevation of yet another embodiment of a temperature sensing syringe for enteral feeding of neonates;

FIG. 6 is a side elevation of another embodiment of a temperature sensing syringe for enteral feeding of neonates;

FIG. 7A is a schematic illustration showing a temperature sensing syringe, before a change in attribute of a thermally sensitive component thereof;

FIG. 7B is a schematic illustration showing the temperature sensing syringe of FIG. 7A, after a change in attribute of the thermally sensitive component thereof;

FIG. 8A is a schematic illustration showing a temperature sensing syringe with a color changing barrel, with liquid contained therein outside of a temperature range;

FIG. 8B is a schematic illustration showing the temperature sensing syringe of FIG. 8A, with liquid contained therein within a desired temperature range;

FIG. 9A is a schematic illustration showing a temperature sensing syringe with a temperature sensing component providing a first temperature range of the liquid contained therein; and

FIG. 9B is a schematic illustration showing the temperature sensing syringe of FIG. 9A with the temperature sensing component providing a second temperature range of the liquid contained therein.

Corresponding reference characters indicate corresponding parts throughout the drawings.

### DETAILED DESCRIPTION OF THE DRAWINGS

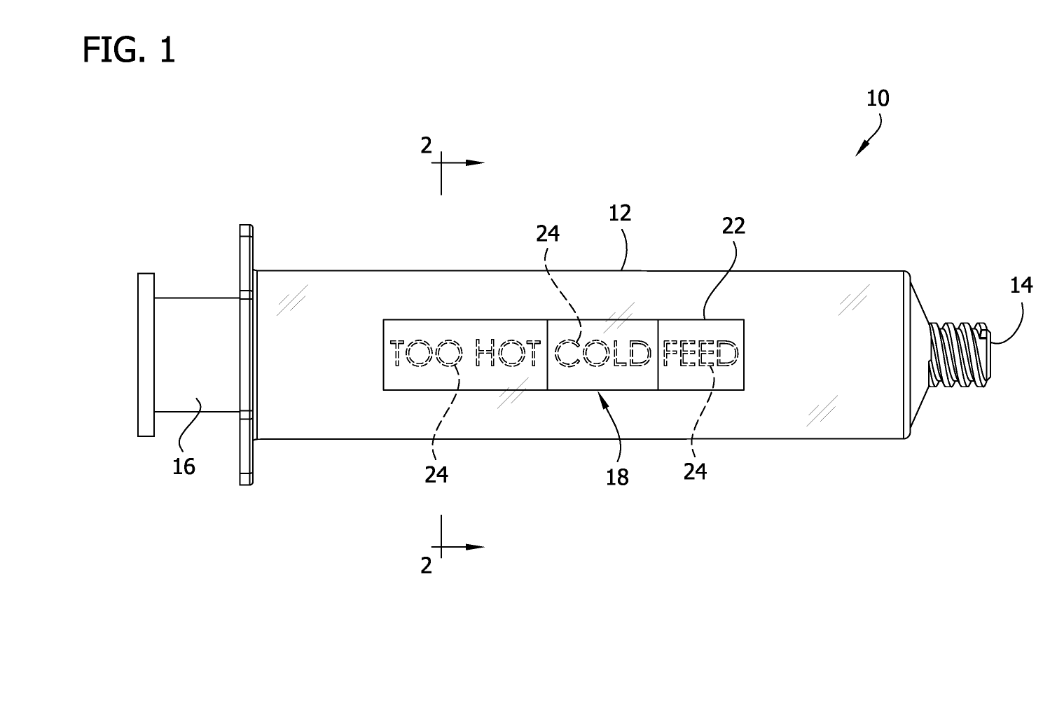

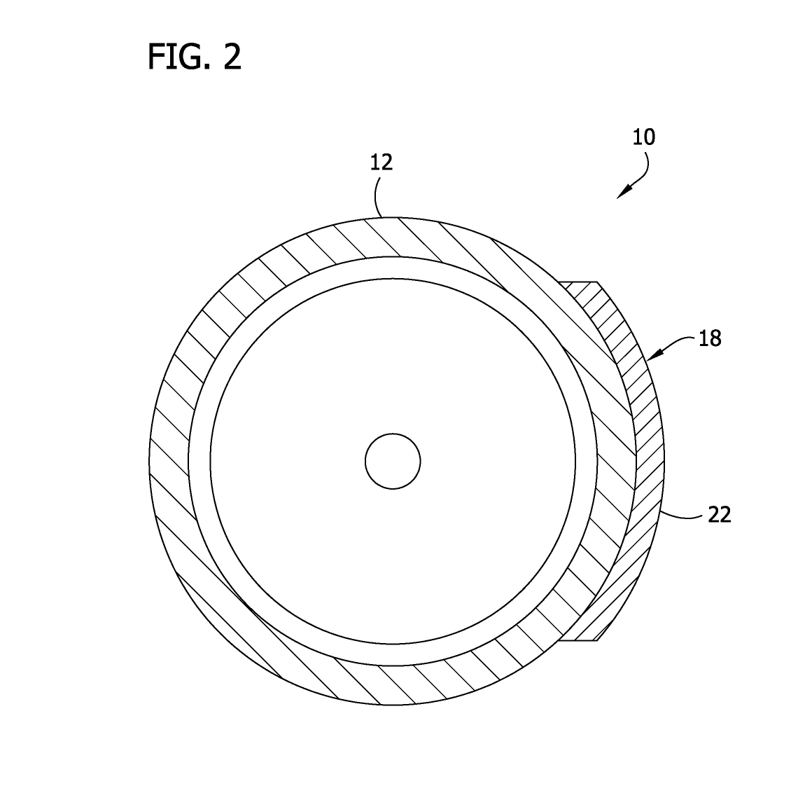

Various features and advantages will be discussed with references to an exemplary temperature sensing or indicating syringe intended for feeding neonates. Referring to FIGS. 1 and 2, a temperature-sensing syringe for use in enteral feeding of neonates is generally indicated at reference numeral 10. The syringe includes a barrel 12, a tip 14 on a distal end of the barrel, and a plunger 16 slidably received in the barrel. The syringe 10 may be of any general construction suitable for delivering enteral feeding liquid to a neonate, e.g., enteral nutrient fluid, breast milk, etc. The syringe 10 further includes a temperature-sensing component 18 for detecting a temperature or providing an indication of a temperature range of the liquid in the barrel 12 of the syringe. In particular, the temperature sensing component 18 is in thermal contact with the barrel 12 such that heat transfers from the enteral liquid to the temperature sensing component or such that component 18 provides an indication of the thermal content of the liquid contained in the barrel. Moreover, in some cases, the temperature-sensing component 18 is configured to change color when it reaches a pre-determined temperature or when the liquid in the barrel is in a predetermined temperature range. Thus, for example, the temperature-sensing component can be thermochromic or can comprise one or more thermochromic components. This change in color indicates the temperature of the enteral liquid in the syringe 10, or at least provides a proxy or an indication as to whether the liquid in the barrel is in a temperature range. For example, the temperature sensing component 18 has a first color when it or if the liquid is at or below a first temperature, e.g., a temperature below about 36.1 C (about 97 degrees F.) or, in some cases, a temperature less than about 32.2 C (about 90 degrees F.), or a first temperature range, e.g., in a range of from about 15.6 C to about 21.1 C (from about 60 degrees F. to about 70 degrees F.), and is configured to change to a second color, which may be the same or different from the first color, when it or the liquid is at a second temperature greater than the first temperature, e.g., from about at or above 97 degrees F. to about 99 degrees F., or in a predetermined temperature range, e.g., from about 32.2 C to about 37.8 C (about 90 degrees F. to about 100 degrees F.). Accordingly, in one example, the temperature-sensing component 18 provides an indication as to whether the temperature of the enteral liquid in the syringe 10 is ready for feeding (e.g., at about body temperature), which may be beneficial when feeding neonates.

In one example, the same temperature sensing component 18, or another temperature sensing component, may be configured to change to a third color, which may be the same or different from the first and second colors, when it or the liquid is at a third temperature greater than the second temperature. Accordingly, in one example, the temperature sensing component 18 indicates if the temperature of the enteral liquid in the syringe is above body temperature and is too warm (or hot) to feed to a neonate, e.g., greater than about 50 C (about 122 degrees F.).

The temperature-sensing component 18 may be configured in any suitable manner for communicating to the user whether the enteral liquid in the syringe 10 is at a desired temperature, or desired temperature range, for enteral feeding. For example, the temperature-sensing component 18 may be configured so that a color change causes a written message or symbol or other indicia depending on the sensed temperature to become visible or more prominently visible. In the illustrated embodiment, the words “TOO HOT,” “COLD,” and “FEED” are displayed based on the temperature sensed by the temperature-sensing component through heat transfer from the enteral liquid in the barrel 12. Ink used for each term on the barrel may have a different sensitivity than the others so that it changes color in a desired temperature range. In another example, the temperature-sensing component 18 may be configured to have a selected color change, e.g., from red to green, indicating whether enteral liquid in the syringe 10 is at the desired temperature, or desired temperature range, for enteral feeding. Other ways of communicating to the user via the temperature-sensing component 18 do not depart from the scope of the present disclosure.

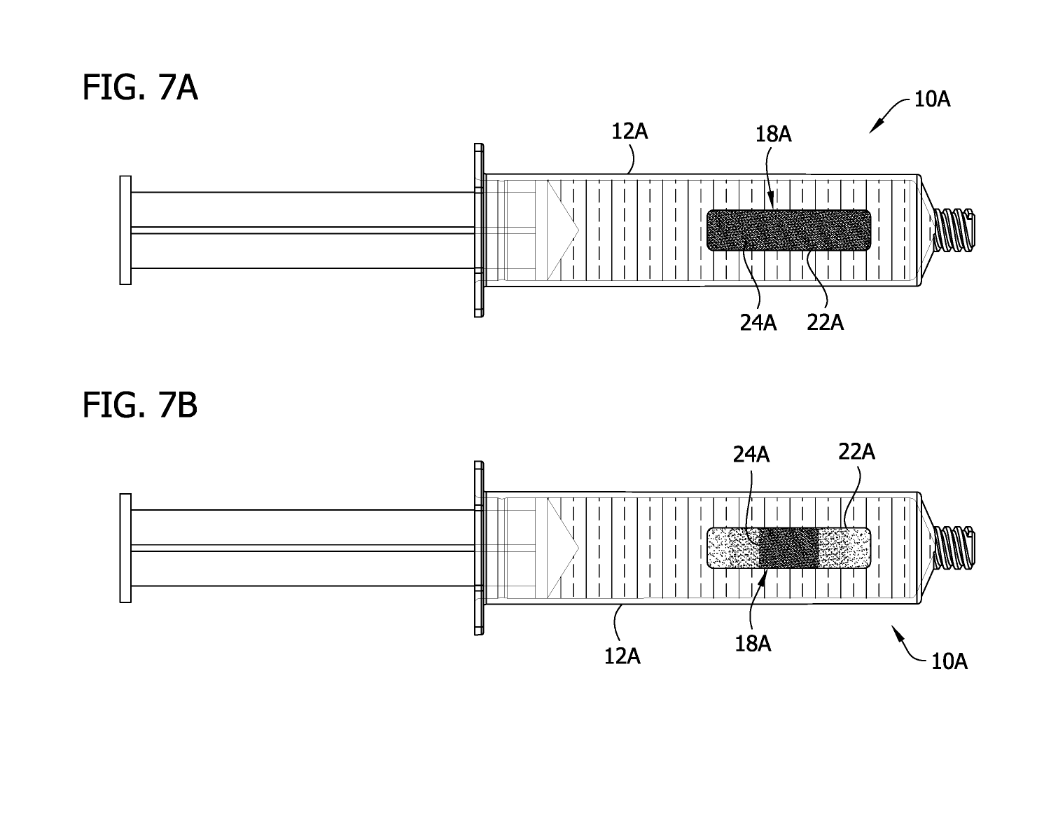

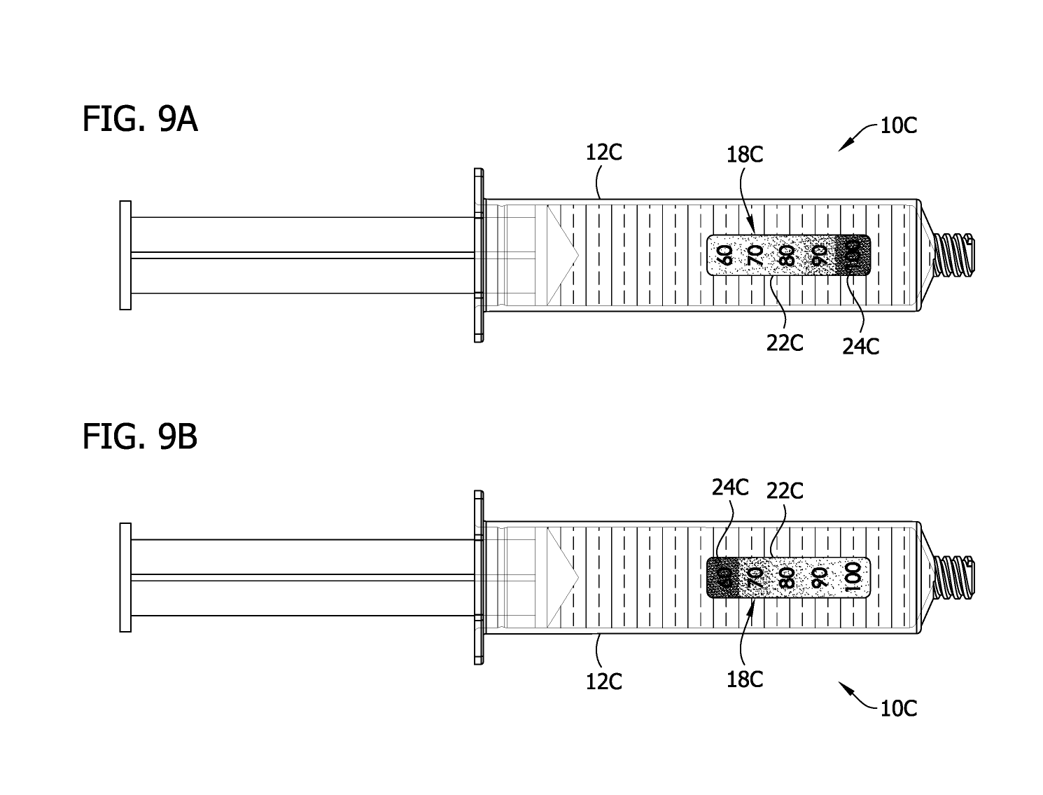

In the illustrated embodiments in FIGS. 1, 2, 7A, 7B, 9A, and 9B, syringes 10, 10A, 10C include a temperature-sensing component 18, 18A, 18C provided on the exterior surface of the barrel 12, 12A, 12C in thermal contact therewith. As a non-limiting example, the temperature-sensing component 18, 18A, 18C may include a substrate 22, 22A, 22C and a thermochromic ink or dye 24, 24A, 24C applied to the substrate. The thermochromic ink or dye is a temperature sensitive material and may comprise thermochromic liquid crystals, leuco dyes, or other materials that are temperature sensitive. In another non-limiting example, a temperature-sensing component 18, 18A, 18C may include thermochromic ink or dye that is applied directly to the exterior surface of the barrel 12, 12A, 12C, without first applying the thermochromic ink or dye to a separate substrate. Other ways of providing the temperature-sensing component on the exterior surface of the barrel 12, 12A, 12C do not depart from the scope of the present disclosure.

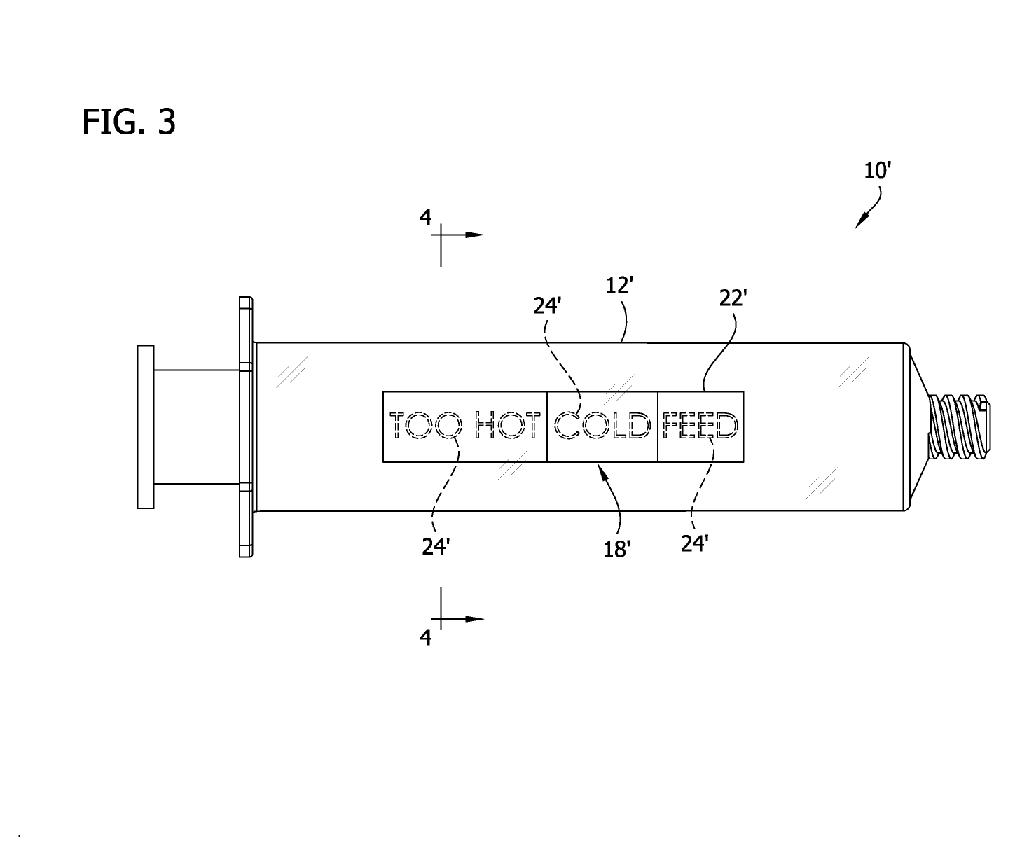

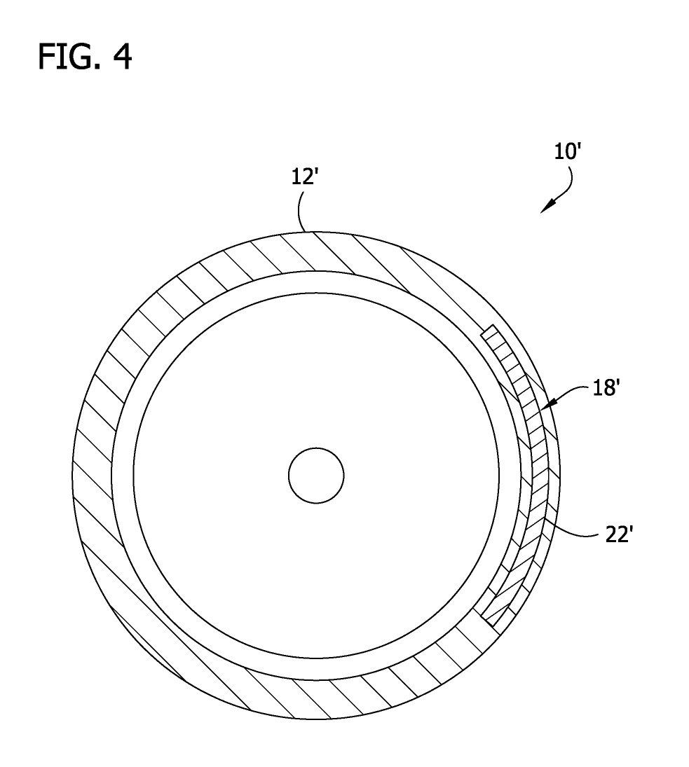

In another embodiment, generally indicated at 10′ in FIGS. 3 and 4, a temperature sensing component, generally indicated at 18′, may be received, e.g., embedded, in the wall of the barrel 12′ between the interior and exterior surfaces of the barrel. The temperature-sensing component 18′ may be similar to the temperature sensing component 18, including a substrate 22′ and a thermochromic ink or dye 24′ applied to the substrate. The wall of the barrel 12′ (or at least a portion thereof) is generally transparent to allow a user to observe the temperature-sensing component 18′ when it changes color. The temperature-sensing component 18′ may be embedded in the wall of the barrel 12′ during manufacture of the barrel or in other ways.

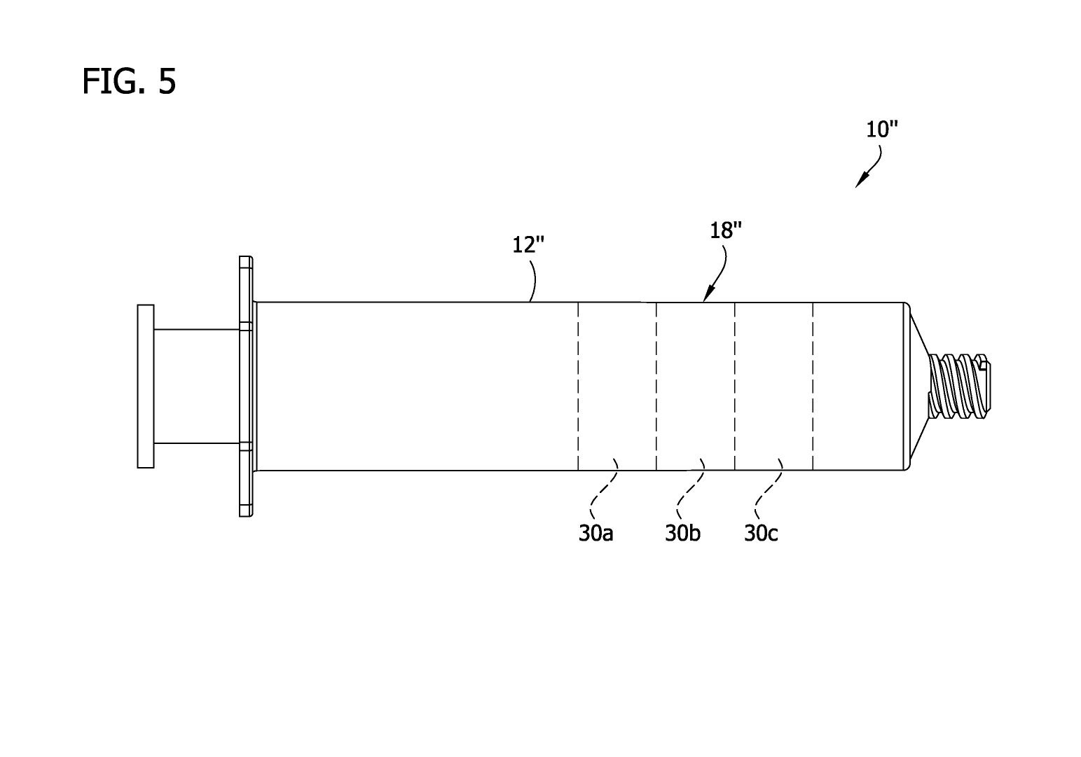

In another embodiment, generally indicated at 10″ in FIG. 5, a temperature-sensing component, generally indicated at 18″, may include one or more areas of the barrel 12″ that is temperature sensitive for indicating whether enteral liquid in the syringe is at a desired temperature for enteral feeding. In the illustrated embodiment, the barrel includes first, second and third temperature-sensitive areas 30a, 30b, and 30c, respectively. As an example, the first temperature-sensitive area 30a may be configured to change color when it is at a desired feeding temperature or in a desired temperature range, e.g., between about 32.2 C and about 37.8 C (between about 90 degrees F. and about 100 degrees F.), or in some cases, in a range between about 36.1 C and about 37.2 C (between about 97 degrees F. and 99 degrees F.); the second temperature-sensitive area 30b may be configured to change color when it is at a temperature above the optimal or desired feeding temperature range, e.g., above about above about 37.2 C (about 99 degrees F.) or, in some cases, 37.8 C (about 100 degrees F.); and the third temperature-sensitive area 30c may be configured to change color when it is at a temperature below the optimal or desired feeding temperature range, e.g., below about 32.2 C (about 90 degrees F.) or, in some cases, below about 36.1 (97 degrees F.). In one example, the temperature-sensitive component 18″ may be formed from a thermoplastic material that is thermochromic. For example, the polymer itself may the thermochromic, or a thermochromic additive, e.g., thermochromic ink or dye, may be embedded in the polymer, or an interaction of the polymer and an embedded non-thermochromic additive may make the polymer thermochromic. The temperature-sensing component 18″ may be of other configurations without departing from the scope of the present disclosure. Thus, depending on the selected desired temperature, one or more visual indicating components may be selectively utilized to provide a visual indication of the temperature of fluid contained in the barrel of the syringe. Any of the plurality of visual indicating components may be adhesively or otherwise secured to the barrel to provide thermal communication of the fluid contained therein to the secured visual indicating component.

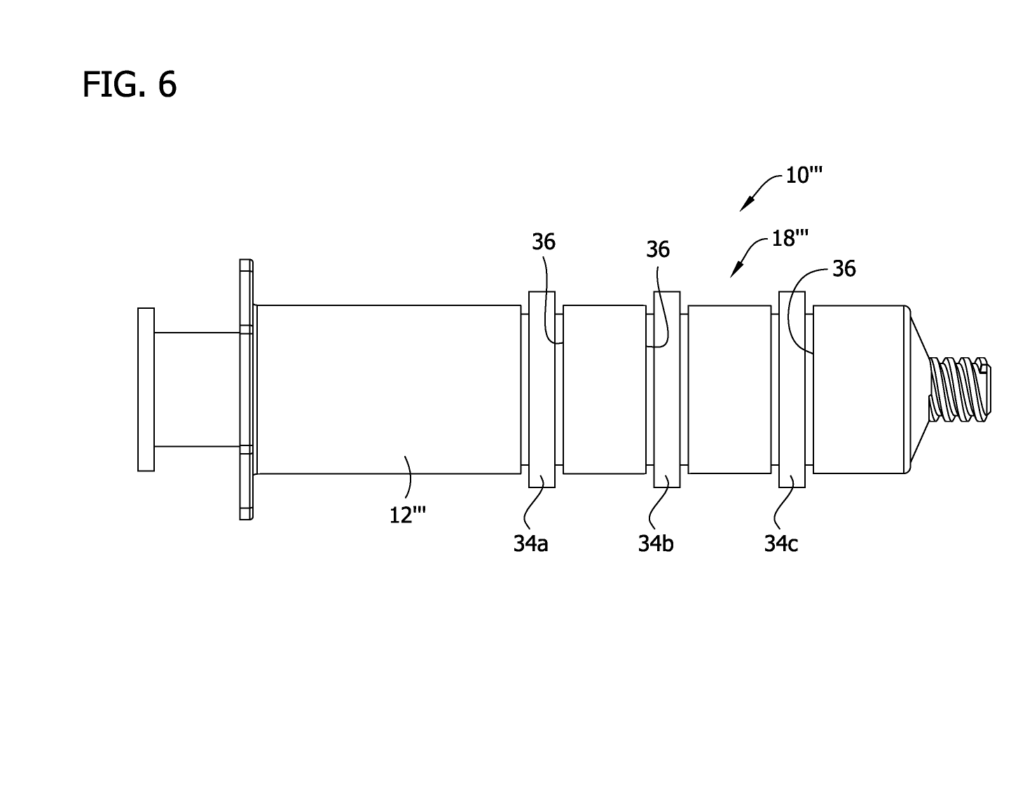

In yet another embodiment, generally indicated at 10′″ in FIG. 6, a temperature sensing component, generally indicated at 18′″, may include one or more bands, e.g., ring members, attached to the barrel 12′″ that is temperature sensitive for indicating whether enteral liquid in the syringe is at a desired temperature for enteral feeding. In the illustrated embodiment, the temperature sensing component includes first, second and third temperature-sensitive annular bands 34a, 34b, 34c, respectively, attached to the barrel 12′. In particular, the annular bands 34a, 34b, 34c are received in respective grooves 36 formed in the exterior of the barrel 12′″. As an example, the first temperature-sensitive annular band 34a may be configured to change color when it is at a desired feeding temperature or in a desired temperature range, e.g., between about 32.2 C and about 37.8 C (between about 90 degrees F. and about 100 degrees F.), or in some cases, in a range of from about 36.1 C and about 37.2 C (between about 97 degrees F. and 99 degrees F.); the second temperature-sensitive annular band 34b may be configured to change color when it is at a temperature above the desired feeding temperature or temperature range, e.g., above about 37.2 C (about 99 degrees F.) or, in some cases, above about 37.8 C (about 100 degrees F.); and the third temperature-sensitive annular band 34c may be configured to change color when it is at a temperature below the desired feeding temperature or temperature range, e.g., below about 32.2 C (about 90 degrees F.) or, in some cases, below about 36.1 C (about 97 degrees F.). In one example, each temperature-sensitive annular band 34a, 34b, 34c may be formed from a thermoplastic polymer that is thermochromic. For example, the polymer itself may the thermochromic, or a thermochromic additive, e.g., thermochromic ink or dye, may be embedded in the polymer, or an interaction of the polymer and an embedded non-thermochromic additive may make the polymer thermochromic. The temperature-sensing component 18″ may be of other configurations without departing from the scope of the present disclosure.

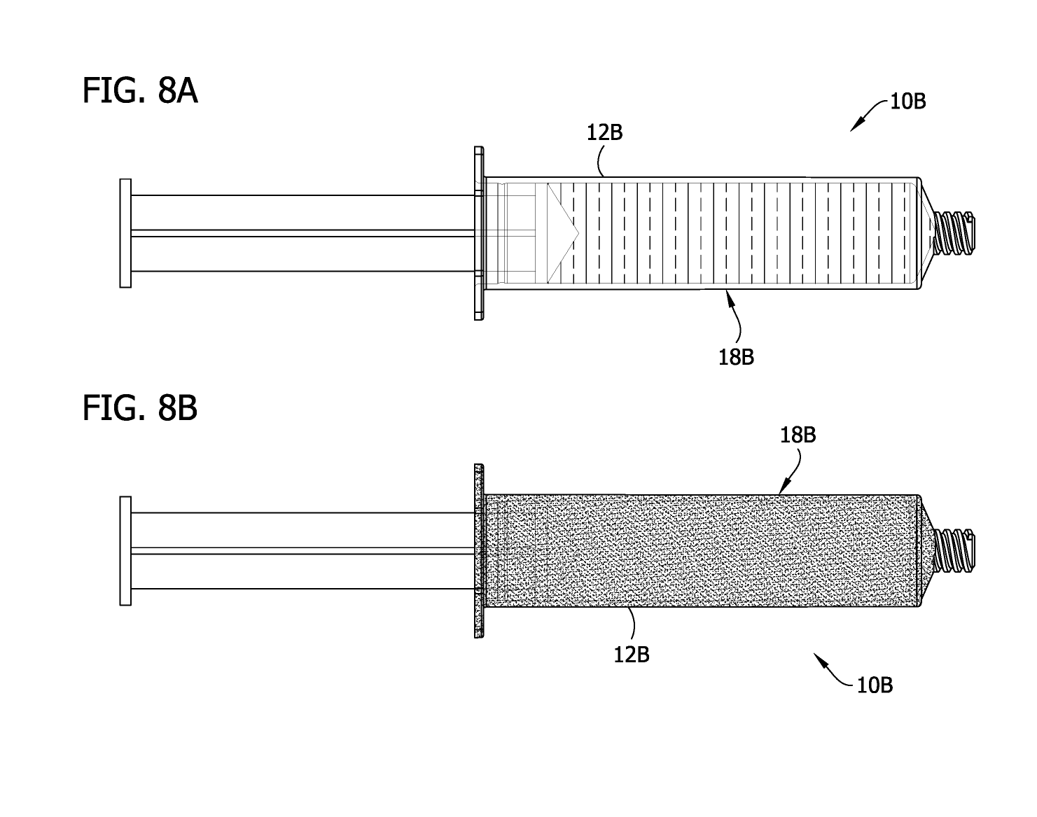

There is further disclosed, with reference to FIGS. 8A and 8B, a neonatal feeding assembly for delivering liquid comprising a syringe 10B having a barrel 12B that provides an indication of the temperature or the range of temperature of the liquid to be delivered. The barrel 12B of the syringe 10B can have incorporated therein a thermochromic material (broadly, “a temperature sensing component 18B”) that changes from a first visible color to a second visible color. Thus in this embodiment, the syringe barrel 12B can have a first color (FIG. 8A) when the barrel, or contents therein, is below a desired temperature or desired temperature range, e.g., below about 32.2 C (about 90 degrees F.) or, in some cases, below about 36.1 C (about 97 degrees F.), and can have a second color (FIG. 8B), e.g., purple, when the barrel, or contents therein, is at a desired temperature or desired temperature range, e.g., in a range of from about 32.2 C to about 37.7 C (about 90 degrees F. to about 100 degrees F.) or, in some cases, in a range of from about 36.1 C to about 37.2 C (about 97 degrees F. to about 99 degrees F.).

In particular configurations, the feeding syringe can have a temperature-sensing component that consists essentially of thermochromic material that provides only two different colors, wherein the first color provides an indication that liquid contained in the syringe is outside of a desired temperature range and wherein the second color provides an indication that the liquid contained in the syringe is within the desired temperature range. In another particular configuration, the feeding syringe can have a temperature-sensing component that consists essentially of thermochromic material that provides only three different colors, wherein the first color provides an indication that liquid contained in the syringe is below a desired temperature range, wherein the second color provides an indication that the liquid contained in the syringe is above the desired temperature range, and wherein the third color provides an indication that the liquid contained in the syringe is within the desired temperature range.

The selection of the desired temperature is not limited to the above disclosed values or ranges. A non-limiting example of the thermochromic component or material includes THERMAX™ indicator, CHROMAZONE™ dispersions, CHROMAZONE™ powders, THERMOSTAR™ ink, and THERMOBATCH™ pigment available from Thermographic Measurements Ltd, Honiton, United Kingdom, and Thermographic Measurements, Glenview, Ill.

Having described the invention in detail, it will be apparent that modifications and variations are possible without departing from the scope of the invention defined in the appended claims.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A temperature sensing syringe for enteral feeding of neonates, the syringe comprising:
a barrel for receiving enteral feeding liquid; and
a temperature-sensing component in thermal contact with the barrel, the temperature-sensing component configured to detect the temperature of the enteral feeding liquid through the barrel of the syringe, the temperature sensing component providing an indication that the enteral feeding liquid is ready for feeding when the enteral feeding liquid is detected to be at about normal body temperature.

2. The temperature-sensing syringe set forth in claim 1, wherein the temperature sensing component indicates the enteral feeding liquid is ready for feeding when the enteral feeding liquid is detected to be in a range of from about 32.2 C to about 37.8 C (about 90 degrees F. to about 100 degrees F.).

3. The temperature-sensing syringe set forth in claim 2, wherein the temperature sensing component indicates the enteral feeding liquid is ready for feeding when the enteral feeding liquid is detected to be in a range of from about 36.1 C to about 37.2 C (about 97 degrees F. to about 99 degrees F.).

4. The temperature-sensing syringe set forth in claim 1, wherein the temperature-sensing component is configured to change color upon reaching a predetermined temperature.

5. The temperature-sensing syringe set forth in claim 4, wherein the temperature-sensing component is configured to change color upon reaching a predetermined temperature in a range of from about 36.1 C to about 37.2 C (about 97 degrees F. to about 99 degrees F.).

6. The temperature-sensing syringe set forth in claim 1, wherein the temperature-sensing component comprises a substrate and a temperature sensitive ink applied to the substrate, wherein the temperature sensitive ink is configured to change color upon reaching a predetermined temperature.

7. The temperature-sensing syringe set forth in claim 6, wherein the temperature-sensing component is attached to an exterior surface of the barrel.

8. The temperature-sensing syringe set forth in claim 6, wherein the temperature-sensing component is embedded in a wall of the barrel.

9. The temperature-sensing syringe set forth in claim 1, wherein the temperature-sensing component comprises temperature sensitive ink applied to an exterior surface of the syringe, wherein the temperature sensitive ink is configured to change color upon reaching a predetermined temperature.

10. The temperature-sensing syringe set forth in claim 1, wherein the temperature-sensing component comprises temperature sensitive ink in thermal contact with the barrel, wherein the temperature sensitive ink provides a written message or symbol indicating the enteral feeding liquid is ready for feeding.

11. The temperature-sensing syringe set forth in claim 1, wherein the temperature-sensing component comprises a temperature sensitive polymer configured to change color upon reaching a predetermined temperature.

12. The temperature-sensing syringe set forth in claim 1, wherein the temperature-sensing component comprises a band of temperature sensitive material mounted on an exterior surface of the syringe, wherein the temperature sensitive material is configured to change color upon reaching a predetermined temperature.

13. A method of facilitating delivery of a nutritional fluid to a neonate through a syringe, comprising:
disposing a temperature-sensing component in thermal communication with a barrel of the syringe, the temperature-sensing component configured to provide a visual indication of the temperature of the nutritional fluid to be contained in the barrel of the syringe, the temperature sensing component providing an indication that the nutritional liquid is ready for feeding when the nutritional liquid is detected to be at about normal body temperature.

14. The method as set forth in claim 13, further comprising selecting the temperature indication component that indicates that the nutritional liquid is ready for feeding when the nutritional liquid is detected in a predetermined temperature range of from about 32.2 C to about 37.8 C (about 90 degrees F. to about 100 degrees F.).

15. The method as set forth in claim 13, wherein the temperature indication component comprises at least one of a temperature sensitive ink and a temperature sensitive polymer.

16. The method as set forth in claim 13, further comprising selecting the temperature indication component that provides a visible color change in a predetermined temperature range of from about 32.2 C to about 37.8 C (about 90 degrees F. to about 100 degrees F.).

17. A kit for facilitating delivery of a fluid to a neonate, the kit comprising:
a syringe having a barrel configured to contain the fluid to be delivered to the neonate; and
a means for providing a visual temperature indicator of the fluid to be contained in the barrel and an indication that the fluid is ready to be delivered to the neonate when the fluid is detected to be at about normal body temperature.

18. The kit as set forth in claim 17, wherein the means for providing a visual temperature indicator of the fluid consists essentially of a plurality of temperature sensitive strips having an adhesive on a side thereof, wherein each of the plurality of temperature sensitive strips has a respective color indicating range.

19. The kit as set forth in claim 18, wherein the plurality of temperature sensitive strips includes at least one temperature sensitive strip having a color indicating range of from about 32.2 C to about 37.8 C (about 90 degrees F. to about 100 degrees F.).

20. The kit as set forth in claim 18, wherein the plurality of temperature sensitive strips includes at least one temperature sensitive strip having a color indicating range of from about 36.1 C to about 37.2 C (about 97 degrees F. to about 99 degrees F.).
